(19) United States
(12) Patent Application Publication
(10) Pub. No.: US 2018/0366738 A1
(43) Pub. Date: Dec. 20, 2018

(54) THERMAL CONTROL OF SUBSTRATES FOR PREVENTION OF IONOMER PERMEATION

(71) Applicant: GM GLOBAL TECHNOLOGY OPERATIONS LLC, Detroit, MI (US)

(72) Inventors: Nagappan Ramaswamy, Rochester Hills, MI (US); Ellazar V. Niangar, Clarkston, MI (US); Balasubramanian Lakshmanan, Rochester Hills, MI (US)

(73) Assignee: GM GLOBAL TECHNOLOGY OPERATIONS LLC, Detroit, MI (US)

(21) Appl. No.: 15/625,579

(22) Filed: Jun. 16, 2017

(51) Int. Cl. H01M 4/88; H01M 4/86

(52) U.S. Cl. CPC H01M 4/8828; H01M 4/8817; H01M 4/8605

(57) ABSTRACT

Systems and methods of the present disclosure include supplying a porous substrate, heating the porous substrate to produce a pre-heated substrate, applying an electrode ink to the pre-heated substrate to produce a coated substrate, and drying the electrode ink of the coated substrate to produce an electrode on the porous substrate. The pre-heated substrate has a temperature greater than 23° C. The applying occurs via a coating mechanism. The electrode ink includes a catalyst and an ionomer dispersed in a solvent. The drying occurs via a drying mechanism.

### INTRODUCTION

The disclosure relates to the field of fuel cells and, more specifically, to systems and methods for inhibiting ionomer permeation into porous substrates.

Fuel-cell systems can be used as a power source in a wide variety of applications to provide electrical energy. The generated electrical energy may be immediately used to power a device such as an electric motor. Additionally or alternatively, the generated electrical energy may be stored for later use by employing, for example, batteries.

In some applications, fuel cells are incorporated into stationary structures to provide electric power to buildings, residences, and the like. In some applications, fuel cells are incorporated into devices such as smart phones, video cameras, computers, and the like. In some applications, fuel cells are incorporated into vehicles to provide or supplement motive power.

Catalyst inks are used in the manufacture of electrodes for fuel cells. The catalyst inks include catalyst powder and ionomers suspended in one or more solvents, such as a mixture of alcohol and water, in a specific ratio. The catalyst ink is then applied onto porous materials such as Gas Diffusion Layers (GDL). After the catalyst ink is laid down on the GDL, the ink is dried in an oven to drive off the solvent from the electrode. However, the laydown of the wet catalyst ink leads to a loss of almost ˜50% of the ionomer within the electrode ink into the porous GDL material. In an attempt to mitigate ionomer permeation, alcohol-rich electrode inks, such as 75% alcohol by volume to 25% water by volume, are used.

### SUMMARY

It is desirable to optimize the ionomer content in the electrode and to inhibit excessive ionomer permeation into porous layers. In some aspects, porous substrates, such as gas diffusion media, are pre-heated prior to application of a catalyst ink to inhibit excessive ionomer permeation into the porous substrates.

According to aspects of the present disclosure, a method includes supplying a porous substrate, heating the porous substrate to produce a pre-heated substrate, applying an electrode ink to the pre-heated substrate to produce a coated substrate, and drying the electrode ink of the coated substrate to produce an electrode on the porous substrate. The pre-heated substrate has a temperature greater than 23° C. The applying occurs via a coating mechanism. The electrode ink includes a catalyst and an ionomer dispersed in a solvent. The drying occurs via a drying mechanism.

According to further aspects of the present disclosure, wherein a first ratio of ionomer to catalyst by volume in the electrode is within 15% of a second ratio of ionomer to catalyst by volume in the electrode ink.

According to further aspects of the present disclosure, wherein the drying mechanism is a second heating mechanism.

According to further aspects of the present disclosure, wherein the electrode ink includes a first amount of ionomer. The electrode ink includes a second amount of ionomer. and the second amount is no less than 70% of the first amount.

According to further aspects of the present disclosure, wherein the electrode ink includes a first amount of ionomer and the electrode ink includes a second amount of ionomer, and the second amount is no less than 90% of the first amount.

According to further aspects of the present disclosure, wherein the temperature is greater than about 50° C.

According to further aspects of the present disclosure, wherein the temperature is greater than about 80° C.

According to further aspects of the present disclosure, wherein the ionomer of the electrode ink migrates no more than about 20 μm into the porous substrate from the electrode.

According to further aspects of the present disclosure, wherein the ionomer of the electrode ink migrates no more than about 10 μm into the porous substrate from the electrode.

According to aspects of the present disclosure, a system comprising a heating mechanism, a coating mechanism disposed downstream of the heating mechanism, and a drying mechanism disposed downstream of the coating mechanism. The heating mechanism is configured to heat a porous substrate to produce a pre-heated substrate. The pre-heated substrate has a temperature greater than 23° C. The coating mechanism includes an applicator configured to apply an electrode ink to the pre-heated substrate. The electrode ink includes a catalyst and an ionomer dispersed in a solvent to thereby produce a coated substrate. The drying mechanism is configured to dry the electrode ink of the coated substrate to produce an electrode on the porous substrate.

According to further aspects of the present disclosure, wherein a first ratio of ionomer to catalyst by volume in the electrode is within 15% of a second ratio of ionomer to catalyst by volume in the electrode ink.

According to further aspects of the present disclosure, wherein the drying mechanism is a second heating mechanism.

According to further aspects of the present disclosure, wherein the electrode ink includes a first amount of ionomer and the electrode ink includes a second amount of ionomer, and the second amount is no less than 70% of the first amount.

According to further aspects of the present disclosure, wherein the electrode ink includes a first amount of ionomer and the electrode ink includes a second amount of ionomer, and the second amount is no less than 90% of the first amount.

According to further aspects of the present disclosure, wherein the temperature is greater than about 50° C.

According to further aspects of the present disclosure, wherein the temperature is greater than about 80° C.

According to further aspects of the present disclosure, wherein the ionomer of the electrode ink migrates no more than about 20 μm into the porous substrate from the electrode.

According to further aspects of the present disclosure, wherein the ionomer of the electrode ink migrates no more than about 10 μm into the porous substrate from the electrode.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

The drawings are illustrative and not intended to limit the subject matter defined by the claims. Exemplary aspects are discussed in the following detailed description and shown in the accompanying drawings in which:

FIG. 1 is a schematic diagram of a fuel-cell system including a fuel-cell stack, according to aspects of the present disclosure;

FIG. 2 is a schematic exploded view of the fuel-cell stack of FIG. 1;

FIG. 3 is a schematic lateral cross-sectional view of a portion of the fuel-cell stack of FIG. 2;

FIG. 4 is a schematic system for producing an electrode on a porous substrate, according to aspects of the present disclosure;

FIGS. 5A-5D are schematic illustrations of a method of assembling an electrode on a porous substrate according to aspects of the present disclosure.

### DETAILED DESCRIPTION

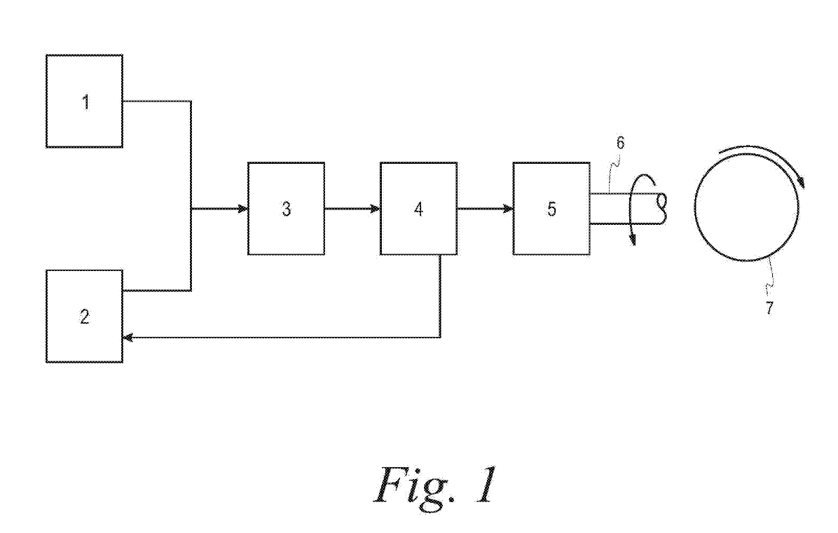

FIG. 1 is a schematic diagram of a fuel-cell system configured to produce motive power. The fuel-cell system includes an oxidant source 1, a fuel source 2, a reactant processing system 3, a fuel-cell stack 4, at least one energy storage device 5, and a motor 6.

The oxidant source 1 and the fuel source 2 provide reactants to the fuel-cell system for generating electrical energy through chemical reactions. As used herein, “reactants” can refer to fuels, oxidants, or both as the context dictates. The reactants include a suitable fuel and oxidant combination. For example, the fuel is hydrogen and the oxidant is oxygen. Other fuels can be used such as natural gas, methanol, gasoline, and coal-derived synthetic fuels, for example.

The reactant processing system 3 receives the oxidant from the oxidant source 1 and/or the fuel from the fuel source 2. In some aspects, the reactant processing system 3 converts raw fuel into a suitable form for the fuel-cell stack 4. For example, the reactant processing system 3 may react methanol to produce hydrogen gas for supplying to the fuel-cell stack 3. In some aspects, the reactant processing system 3 additionally or alternatively conditions one or more of the reactants by adjusting factors such as temperature, pressure, humidity, and the like. In some aspects, the reactant processing system 3 may be omitted.

The fuel-cell stack 4 is configured to receive the reactants from the reactant processing system 3 and produce electrical energy by promoting redox reactions. For example, hydrogen fuel can be reacted with oxygen to produce electricity with heat and water as by-products.

The energy storage device 5 is configured to receive energy produced by the fuel-cell stack 4 and provide the energy to ancillary components. The energy storage device 5 may store the power for later use, or may use the power substantially instantaneously to thereby provide a buffer against power fluctuations that may damage ancillary components such as the motor 6.

The motor 6 is configured to convert the electrical energy stored in the energy storage device into work. The motor 6 can be used to drive, for example, a motive device such as a wheel 7.

FIG. 2 is an exploded view of the fuel-cell stack 4. The fuel-cell stack 4 includes a plurality of plates 12, at least one fuel cell 14, and a compressive member 16. The plurality of plates 12 may include a suitable combination of plates 12 such as endplates 18, monopolar plates 20, bipolar plates 22, combinations thereof, and the like. Each of the monopolar plates 20 is disposed adjacent a respective fuel cell 14, and each of the bipolar plates 22 is disposed between a pair of fuel cells 14.

The compressive member 16 is configured to apply a compressive force to the fuel-cell stack 4 along the stacking direction. The compressive force secures the plates 12 and fuel cells 14 in position through a contact pressure between adjacent components. In some aspects, the compressive member 16 includes a plurality of threaded rods that engage structures on the endplates 18. By tightening the threaded rods, a compressive force is increased to a desired level along the stacking direction which results in a contact pressure being distributed along seals between adjacent components. In some aspects, the compressive members 16 engage less than the entire fuel-cell stack 4. For example, compressive members 16 may engage two adjacent plates 12 to apply a compressive force to the two plates 12 or may engage a number of adjacent plates 12 to apply a compressive force to the number of adjacent plates 12.

The endplates 18 are disposed at the top and bottom of the fuel-cell stack 4. The endplates 18 include fuel inlets 24a, fuel outlets 24c, oxidant inlets 26a, oxidant outlets 26c, coolant inlets 28a, and coolant outlets 28c disposed thereon. As used herein, “fluids” can refer to fuels, oxidants, coolants, or any combination thereof as the context dictates. For example, “fluid inlets 24a, 26a, 28a” can refer to any or all of fuel inlets 24a, oxidant inlets 26a, or coolant inlets 28a as the context dictates, and “reactant channels 24b, 26b” can refer to either or both of fuel channels 24b and oxidant channels 26b as context dictates. It is contemplated that certain of the fluid inlets 24a, 26a, 28a and fluid outlets 24c, 26c, 28c can be located on one endplate 18 with the remaining fluid inlets 24a, 26a, 28a and fluid outlets 24c, 26c, 28c being located on the opposite endplate 18.

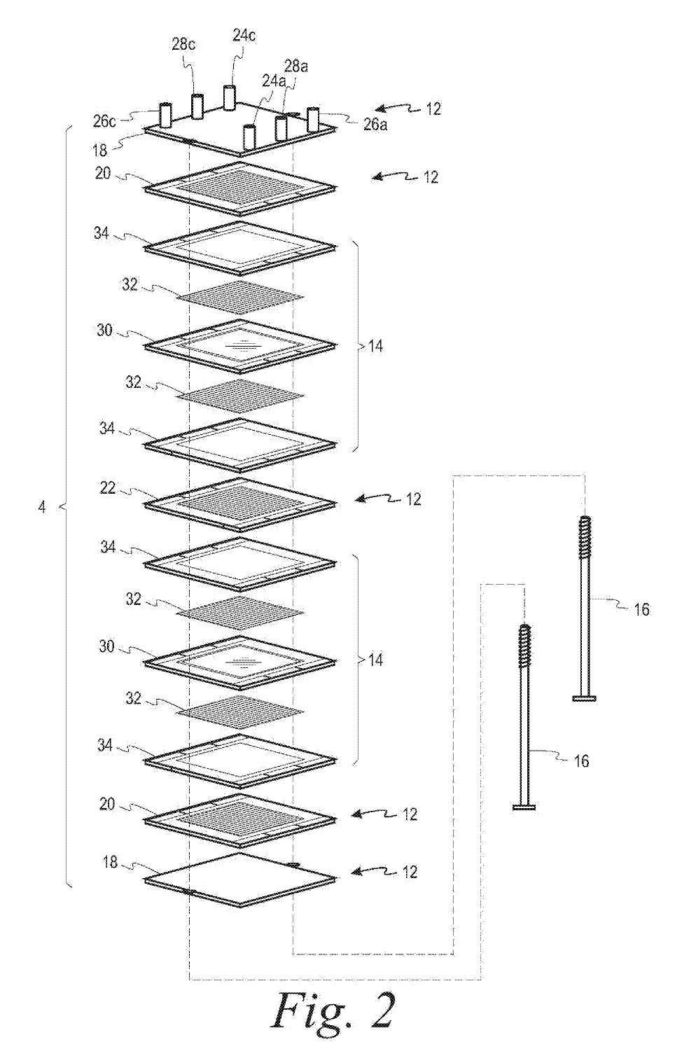

FIG. 3 illustrates a lateral cross-sectional view of a fuel cell 14 of the fuel-cell stack 4. The fuel cell 14 includes a membrane-electrode assembly 30 and gas-diffusion media 32 with an optional gasket 34 (FIG. 2). The gas-diffusion media 32 are porous layers that facilitate delivery of reactants from the reactant channels 24b, 26b of the bipolar plates 22 to the membrane-electrode assembly 30. The gas-diffusion media 32 include a porous layer 36 and a micro-porous layer 38. In some aspects, the gas-diffusion media 32 is a unitary structure defining the porous layer 36 at a first surface and the micro-porous layer 38 at a second surface opposite the first surface. It is contemplated that the gas-diffusion media 32 may include, for example, only the porous layer 36 or only the micro-porous layer 38.

In some aspects, the gas-diffusion media 32 are configured to provide a consistent local concentration of reactants across the face of the membrane-electrode assembly 30 such that portions of the membrane-electrode assembly 30 aligned with lands of the adjacent plate 12 receive substantially the same exposure to reactants as portions of the membrane-electrode assembly 30 aligned with reactant channels 24b, 26b of the adjacent plate 12.

The gas-diffusion media 32 also provide electrically conduction, thermal conduction, and mechanical support. The gas-diffusion media 32 are formed from suitable materials, such as polymers or coated materials, to optimize desired performance parameters. In some aspects, the gas-diffusion media 32 or portions thereof are formed from carbon paper, carbon cloth, or fluoropolymers such as polytetrafluoroethylene (“PTFE”). In some aspects, the gas-diffusion media 32 include carbon paper fluoropolymers coating the strands.

The membrane-electrode assembly 30 is configured to generate an electric charge by facilitating reduction and oxidation of the reactants. The membrane-electrode assembly 30 includes a membrane 40 disposed between a pair of electrodes 42 defining an anode side 44 and a cathode side 46. The electrode 42 on the anode side 44 is configured to facilitate ionization of the fuel. For example, hydrogen gas is separated into two protons and two electrons at the electrode. The electrode 42 on the cathode side 46 is configured to facilitate combination of the ionized fuel with the oxidant. For example, oxygen is combined with the two protons and two electrons to produce one water molecule.

The electrodes 42 include, for example, a finely divided catalyst disposed on support particles and mixed with an ionomer. The catalyst is configured to catalyze the half-cell reaction of the respective reactants. The catalyst of the anode side 44 may be different from the catalyst of the cathode side 46. In some aspects, the anode-side catalyst is platinum and the cathode-side catalyst is nickel. In some aspects, the anode-side catalyst is platinum and the cathode-side catalyst is platinum or based on platinum. The support particles are configured to increase the catalytic ability of a given amount of catalyst. Catalytic ability is increased, for example, by the catalyst forming a plurality of lands on exposed surfaces of the support particles such that a predetermined number of reaction sites are provided while the amount of catalyst is reduced as compared to unsupported catalyst. In some aspects, the support particles are carbon. The ionomer is configured to provide ion transport to the catalyst particles. In some aspects, the ionomer is polystyrene sulfonate, perfluorosulfonic acid polymer, a tetrafluoroethylene and perfluorosulfonic acid copolymer, or a sulfonated block copolymer.

The membrane 30 is configured to transport ions from the electrode 42 on the anode side 44 to the electrode 42 on the cathode side 46 while inhibiting transfer of electrons therethrough. In some aspects, the membrane 40 is a proton-exchange membrane configured to transfer protons therethrough.

While the illustrated structure and composition of the anode side 44 and the cathode side 46 are substantially symmetrical about the membrane 40, it is contemplated that components of the anode side 44 can include properties which differ from those of the cathode side 46.

In some aspects, the gas-diffusion media 32 of the cathode side 46 are also configured to transport products such as water away from the membrane-electrode assembly 30 to inhibit flooding. For example, in some aspects, the gas-diffusion media 32 of the cathode side 46 is thicker than that of the anode side to control mass flow of water to and from the membrane 40. Additionally or alternatively, in some aspects, at least a portion of the gas-diffusion media 32 of the cathode side 46 is hydrophobic to control mass flow of water therethrough. The porous layer 34, the micro-porous layer 36, or both may be hydrophobic.

Bipolar plates 22 can be formed using a variety of methods such as additive manufacturing including 3D-printing or other standard forming techniques. For example, the rear faces 38 of two monopolar plates 20 can be placed together and the monopolar plates 20 bonded to form the bipolar plate 22. The bond can be formed by, for example, welding or use of an adhesive. In some aspects, the bipolar plate 22 is formed by stamping reactant channels 24b, 26b onto opposite faces of a single sheet without the presence of cooling channels 28b therebetween.

During assembly of the fuel cell 14, suspensions may be coated onto porous substrates to form resulting layers of the fuel cell 14. For example, an electrode ink may be coated onto the gas-diffusion media 32 to form the electrode 42. The electrode ink may be a mixture containing the loaded catalyst-support particles and the ionomer in a solvent. The electrode ink may be a solution, a suspension, a colloid, or combination thereof

The solvent may be a mixture of different liquids. In some aspects, the electrode ink includes the loaded catalyst-support particles and the ionomer dispersed in a mixture of an organic solvent, such as alcohol, and inorganic solvent, such as water. In a mixture of water and alcohol, as water concentration increases, proton-transport resistance of the resultant layer increases while local oxygen-transport resistance of the resultant layer decreases. As used herein, the local oxygen-transport resistance is measured in

$$\frac{s}{cm} / \frac{{cm}_{Pt}^{2}}{{cm}_{geo}^{2}} ,$$

hereinafter referred to as “units,” where cm_{Pt}², is surface area of platinum nanoparticle catalysts and cm_{geo}² is the geometric surface of the electrode.

For example, local oxygen-transport resistance of 5 cm² of catalyst-coated membrane in a membrane-electrode assembly measured at 80° C., relative humidity of 100%, pressure of 150 kPaa, and current density of 2 A/cm² is 10.1 s/cm for an electrode ink having a mixture of 80% alcohol by volume and 20% water by volume, 8.2 s/cm for an electrode ink having a mixture of 40% alcohol by volume and 60% water by volume, and 6.5 s/cm for an electrode ink having a mixture of 20% alcohol by volume and 80% water by volume. Additionally, the proton transport resistance of 5 cm² of catalyst-coated membrane in a membrane-electrode assembly measured at a temperature of 80° C., relative humidity of 95%, and pressure of 150 kPaa is 68.2 mΩ-cm² for an electrode ink having a mixture of 80% alcohol by volume and 20% water by volume, 78.5 mΩ-cm² for an electrode ink having a mixture of 40% alcohol by volume and 60% water by volume, and 83.0 mΩ-cm² for an electrode ink having a mixture of 20% alcohol by volume and 80% water by volume.

Coating liquids onto porous substrates allows material from the liquid to migrate into the porous substrate. For example, an ionomer within the electrode ink may permeate the gas-diffusion media 32. What is more, other material from the liquid may not permeate the porous substrate, or may permeate the porous substrate at a different rate from the first material, which negatively affects the composition and ratio of material within the resulting layer. For example, while the ionomer may permeate the gas-diffusion media 32, the catalyst-support particles and catalyst remain substantially within the resulting electrode 42.

The migration of material from the liquid into the porous substrate increases component cost by increasing the initial amount of material required to produce a resultant layer having a desired amount of material. What is more, the proportion of material to other components of resulting layer is also affected because, if other materials migrate at different rates or not at all, the resulting layer would have a less-than-optimal ratio of material. For example, the ionomer of the electrode ink will leach into the gas diffusion media 32 while the loaded catalyst-support particles remain substantially within the electrode ink to produce an electrode 42 with a catalyst-to-ionomer ratio that is higher than the catalyst-to-ionomer ratio of the electrode ink.

Beneficially, systems and methods in accordance with the present disclosure yield optimized electrode designs. Systems and methods in accordance with the present disclosure raise the temperature of the porous substrate to reduce or prevent migration of material from the liquid to the porous substrate. This reduces the overall amount of material needed to produce the desired layers. For example, when forming the electrodes 42, systems and methods in accordance with the present disclosure reduce the amount of ionomer used and optimize the ratio of catalyst-to-ionomer in the resulting electrode 42 by minimizing the difference between catalyst-to-ionomer ratios of the electrode ink and the electrode 42.

What is more, systems and methods in accordance with the present disclosure provide for mid-range mixtures of electrode inks, such as 40% alcohol by volume and 60% water by volume, without substantial loss of ionomer from the resulting electrode 42. In some aspects, a non-preheated porous substrate absorbs more than about 45% of ionomer in the mid-range electrode ink while a preheated porous substrate absorbs less than 10% of the ionomer, which improves balance between proton-transport resistance and local oxygen-transport resistance.

Systems and methods described herein also inhibit pooling of material at the interface between the porous substrate and the resulting layer. Systems and methods in accordance with the present disclosure provide benefits to both cathodes and anodes of fuel cells. Additionally, maintaining sufficient ionomer content in the anode electrode provides further benefits by removing the need for anode top coat process.

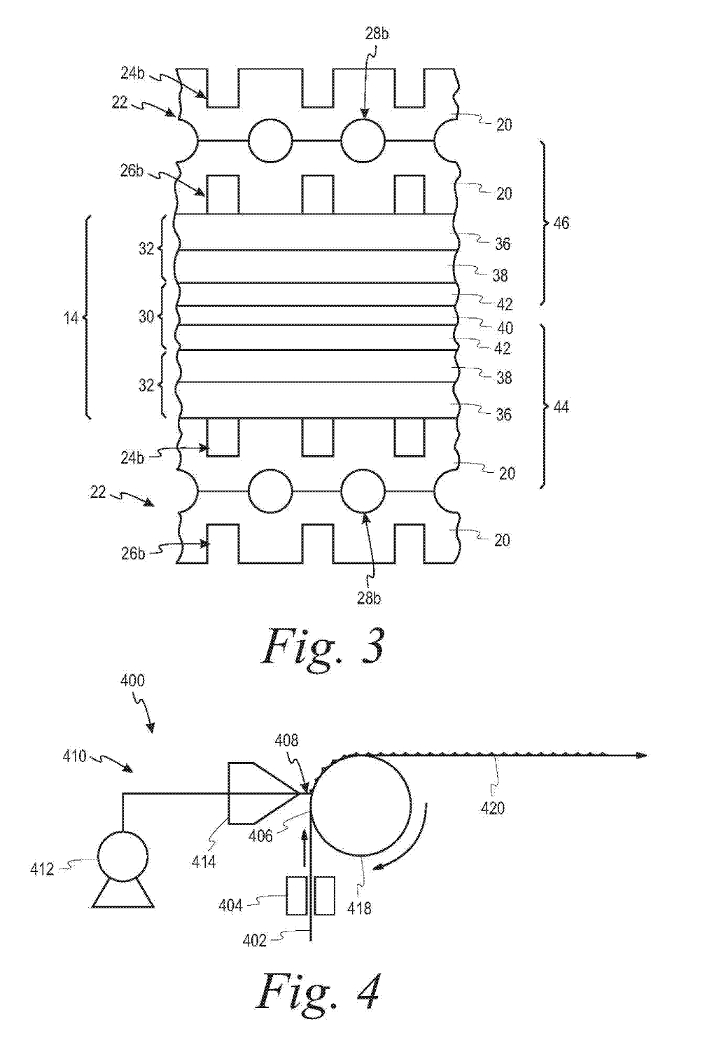

FIG. 4 illustrates a system 400 for producing an electrode 42 on a porous substrate 402 such as porous layer 36 or micro-porous layer 38. The porous substrate 402 is supplied to the system 400 and is heated via heating mechanism 404 to produce a pre-heated substrate 406. The heating mechanism 404 may employ radiative heating, convective heating, conductive heating, or combinations thereof. In some aspects, the heating mechanism is an oven. The temperature of the pre-heated substrate 406 is above ambient temperature. In some aspects, the temperature of the pre-heated substrate 406 is greater than about 23° C. to reduce permeation. In some aspects, the temperature of the pre-heated substrate 406 is greater than about 35° C. to reduce permeation. In some aspects, the temperature of the pre-heated substrate 406 is greater than about 50° C. to reduce permeation. In some aspects, the temperature of the pre-heated substrate 406 is greater than about 83° C. to reduce permeation.

An electrode 42 is applied to the pre-heated substrate 406 in a liquid form such as an electrode ink 408 to produce a coated substrate 420. The electrode ink 408 is applied by a coating mechanism 410 including, for example, a pump 412 and an applicator 414. The pump 412 is configured to receive the electrode ink from a source and increase the pressure to a predetermined amount. The electrode ink is then piped through the applicator 414 such as ink jet printer, screen printer, flexographic printer, slot die, or the like and applied to the pre-heated substrate 406. A conveying mechanism 418 carries the coated substrate 420 to optional downstream processes such as drying mechanisms, separating mechanisms, combinations thereof, and the like. For example, a second heating mechanism 404 may be placed downstream from the coating mechanism 410 to heat at least the porous substrate 402.

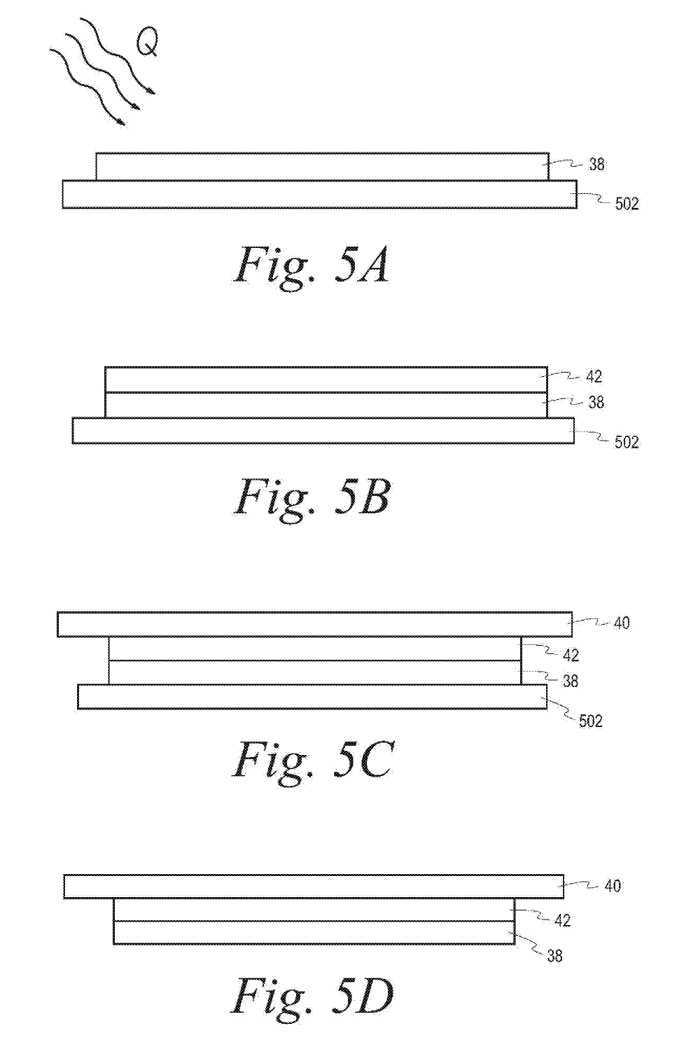

FIGS. 5A-5D illustrate a method of assembling an electrode 42 on a porous substrate, shown as micro-porous layer 38. It is to be understood that the porous substrate may be a micro-porous layer 38, porous layer 36, or a micro-porous layer 38 and a porous layer 36. FIG. 5A illustrates heating the micro-porous layer 38. The micro-porous layer 38 may be supplied with or without a decal blank 502. In some aspects, the decal blank 502 may be polytetrafluoroethylene (PTFE), expanded PTFE, polyimide films such as poly(4,4′-oxydiphenylene-pyromellitimide), combinations thereof, and the like.

Heat Q is added to the porous substrate to produce the pre-heated substrate 406 to raise the temperature of the pre-heated substrate 406 above ambient temperature. In some aspects, the temperature of the pre-heated substrate 406 is greater than about 23° C. In some aspects, the temperature of the pre-heated substrate 406 is greater than about 50° C. In some aspects, the temperature of the pre-heated substrate 406 is greater than about 80° C.

As shown in FIG. 5B, the electrode ink is applied to the pre-heated substrate 406 to produce a coated substrate after the temperature of the pre-heated substrate 406 is raised above a predetermined threshold. The coated substrate is then dried to produce the electrode 42 on the micro-porous layer 38. The membrane 40 is then provided over the electrode 42 as shown in FIG. 5C. In some aspects, the decal blank 502, the microporous layer 38, and the electrode 42 are hot pressed to the membrane 40. Conditions of temperature, pressure, and time for hot pressing known in the art may be used. For example, the hot-pressing conditions may include a pressing time of 4 minutes at 295° F. and 250 psi. As shown in FIG. 5D, the decal blank 502 may be peeled away, if desired, to leave the micro-porous layer 38 attached to the electrode 42, which is attached to the membrane 40. The process may then be repeated with a second decal blank to produce the structure on the opposite side of the membrane 40.

### EXAMPLES

### Example 1

Samples are prepared employing preheated substrates at various temperatures. The porous substrates are micro-porous layers with a 35 μm thickness. The microporous layers are heated to the respective pre-heated temperatures. After each microporous layer reaches the respective pre-heated temperature, the electrode ink is coated onto the pre-heated micro-porous layer. After the electrode ink dries, ionomer retention of the resulting electrode layer is determined using electron probe micro analysis. The results are given in the Table 1 below.

TABLE 1
Ionomer Retention and Loss

| Temperature of | Ionomer Retention by | Ionomer Loss into Micro- |
|---|---|---|
| Substrate | resultant Electrode | Porous Layer |
| 23° C. | ~55% | ~45% |
| 40° C. | ~62% | ~38% |
| 45° C. | ~65% | ~35% |
| 50° C. | ~73% | ~27% |
| 60° C. | ~78% | ~22% |
| 70° C. | ~88% | ~12% |
| 83° C. | ~90% | ~10% |
| 102° C. | ~92% | ~8% |

From the above, it is calculated that the catalyst ink for a substrate at 23° C. will require an ionomer-to-catalyst ratio of approximately 1.6 to arrive at an electrode having an ionomer-to-catalyst ratio of 0.9, whereas the catalyst ink for a substrate at 83° C. will only require an ionomer-to-catalyst ratio of approximately 1.0 to arrive at an electrode having an ionomer-to-catalyst ratio of 0.9.

### Example 2

Samples of Example 1 are selected to analyze permeation of electrode ink materials into the micro-porous layer. Permeation of the ionomer is determined using a sulfur intensity profile and permeation of the catalyst and catalyst-support particles are determined using a platinum intensity profile. The results are given in the Table 2 below.

TABLE 2
Material Permeation Distances

| Temperature of | Ionomer permeation | Catalyst permeation |
|---|---|---|
| Substrate | distance | distance |
| 23° C. | ~35 μm | ~0 μm |
| 50° C. | ~22 μm | ~0 μm |
| 83° C. | ~10 μm | ~0 μm |

While the best modes for carrying out the disclosure have been described in detail, those familiar with the art to which this disclosure relates will recognize various alternative designs and embodiments for practicing the disclosure within the scope of the appended claims.

What is claimed is:

1. A method comprising:
supplying a porous substrate;
heating, via a heating mechanism, the porous substrate to produce a pre-heated substrate, the pre-heated substrate having a temperature greater than 23° C.;
applying, via a coating mechanism, an electrode ink to the pre-heated substrate, the electrode ink including a catalyst and an ionomer dispersed in a solvent to thereby produce a coated substrate; and
drying, via a drying mechanism, the electrode ink of the coated substrate to produce an electrode on the porous substrate.

2. The method of claim 1, wherein a first ratio of ionomer to catalyst by volume in the electrode is within 15% of a second ratio of ionomer to catalyst by volume in the electrode ink.

3. The method of claim 1, wherein the drying mechanism is a second heating mechanism.

4. The method of claim 1, wherein the electrode ink includes a first amount of ionomer, the electrode ink includes a second amount of ionomer, and the second amount is no less than 70% of the first amount.

5. The method of claim 1, wherein the electrode ink includes a first amount of ionomer and the electrode ink includes a second amount of ionomer, and the second amount is no less than 90% of the first amount.

6. The method of claim 1, wherein the temperature is greater than about 50° C.

7. The method of claim 1, wherein the temperature is greater than about 80° C.

8. The method of claim 1, wherein the ionomer of the electrode ink migrates no more than about 20 μm into the porous substrate from the electrode.

9. The method of claim 1, wherein the ionomer of the electrode ink migrates no more than about 10 μm into the porous substrate from the electrode.

10. A system comprising:
a heating mechanism configured to heat a porous substrate to produce a pre-heated substrate, the pre-heated substrate having a temperature greater than 23° C.;
a coating mechanism disposed downstream of the heating mechanism, the coating mechanism including an applicator configured to apply an electrode ink to the pre-heated substrate, the electrode ink including a catalyst and an ionomer dispersed in a solvent to thereby produce a coated substrate; and
a drying mechanism disposed downstream of the coating mechanism, the drying mechanism configured to dry the electrode ink of the coated substrate to produce an electrode on the porous substrate.

11. The system of claim 10, wherein a first ratio of ionomer to catalyst by volume in the electrode is within 15% of a second ratio of ionomer to catalyst by volume in the electrode ink.

12. The system of claim 10, wherein the drying mechanism is a second heating mechanism.

13. The system of claim 10, wherein the electrode ink includes a first amount of ionomer and the electrode ink includes a second amount of ionomer, and the second amount is no less than 70% of the first amount.

14. The system of claim 10, wherein the electrode ink includes a first amount of ionomer and the electrode ink includes a second amount of ionomer, and the second amount is no less than 90% of the first amount.

15. The system of claim 10, wherein the temperature is greater than about 50° C.

16. The system of claim 10, wherein the temperature is greater than about 80° C.

17. The system of claim 10, wherein the ionomer of the electrode ink migrates no more than about 20 μm into the porous substrate from the electrode.

18. The system of claim 10, wherein the ionomer of the electrode ink migrates no more than about 10 μm into the porous substrate from the electrode.
